(19) United States
(12) Patent Application Publication
(10) Pub. No.: US 2024/0175105 A1
(43) Pub. Date: May 30, 2024

(54) LEACHING AGENT COMPOSITION AND METHOD OF REMOVING METAL FROM CATALYST MATERIAL

(71) Applicant: Saudi Arabian Oil Company, Dhahran (SA)

(72) Inventors: Omer Refa KOSEOGLU, Dhahran (SA); Robert Peter HODGKINS, Dhahran (SA)

(21) Appl. No.: 18/053,848

(22) Filed: Nov. 9, 2022

(51) Int. Cl. C22B 7/00; C22B 3/00; C22B 34/34

(52) U.S. Cl. CPC C22B 7/009; C22B 23/0407; C22B 34/345

(57) ABSTRACT

A leaching agent composition, and a method of using the leaching acid composition to remove metal from catalyst material, are provided in which the leaching agent composition comprises oxidized disulfide oil (ODSO). Active phase metals and/or contaminant metals are removed, for example after typical oil removal and drying steps. Advantageously, ODSO, which is derived from a refinery waste stream, is used to replace and/or supplement commonly used leaching acid such as sulfuric or nitric acid to remove metals used in catalyst preparation or contaminant metals deposited onto the catalyst surface.

### TECHNICAL FIELD

Embodiments of the present disclosure generally relate to leaching agents and methods recovering metals from catalysts with leaching agents.

### DESCRIPTION OF RELATED ART

Catalysts have been used widely in the refining and chemical processing industries for many years. For example, hydroprocessing catalysts including hydrotreating and hydrocracking catalysts, and catalytic reforming catalysts, are widely utilized. Typical hydroprocessing and reforming catalysts include supported catalysts in which a support material, formed of microporous and/or mesoporous crystalline and/or amorphous materials, loaded with one or more catalytically active phase metals. Common catalytically active phase metals for hydroprocessing include, for example, nickel, molybdenum, cobalt and/or tungsten. In some cases, for example in catalytic reforming, noble metals such as platinum, palladium, iridium and/or rhodium may be used.

During use of hydroprocessing as well as other refinery processes such as fluidized catalytic cracking (FCC), contaminant metals from the feedstream accumulate on the catalyst particles. These metals present in the feedstream acted upon by the catalysts include, for example, nickel, vanadium and iron. Removal of metals from spent catalyst is practiced for various purposes, including reclaiming the metals and/or restoring catalytic activity to the catalyst material.

Within a typical refinery, there are by-product streams that must be treated or otherwise disposed of. The mercaptan oxidation process, commonly referred to as the MEROX process, has long been employed for the removal of the generally foul smelling mercaptans found in many hydrocarbon streams and was introduced in the refining industry over fifty years ago. Because of regulatory requirements for the reduction of the sulfur content of fuels for environmental reasons, refineries have been, and continue to be faced with the disposal of large volumes of sulfur-containing by-products. Disulfide oil (DSO) compounds are produced as a by-product of the MEROX process, in which the mercaptans are removed from any of a variety of petroleum streams including liquefied petroleum gas, naphtha, and other hydrocarbon fractions. It is commonly referred to as a ‘sweetening process’ because it removes the sour or foul smelling mercaptans present in crude petroleum. The term “DSO” is used for convenience in this description and in the claims, and will be understood to include the mixture of disulfide oils produced as by-products of the mercaptan oxidation process. Examples of DSO include dimethyldisulfide, diethyldisulfide, and methylethyldisulfide.

The by-product DSO compounds produced by the MEROX unit can be processed and/or disposed of during the operation of various other refinery units. For example, DSO can be added to the fuel oil pool at the expense of a resulting higher sulfur content of the pool. DSO can be processed in a hydrotreating/hydrocracking unit at the expense of higher hydrogen consumption. DSO also has an unpleasant foul or sour smell, which is somewhat less prevalent because of its relatively lower vapor pressure at ambient temperature; however, problems exist in the handling of this oil.

Commonly owned U.S. Pat. No. 10,807,947 which is incorporated by reference herein in its entirety discloses a controlled catalytic oxidation of MEROX process by-products DSO. The resulting oxidized material is referred to as oxidized disulfide oil (ODSO). As disclosed in U.S. Pat. No. 10,807,947, the by-product DSO compounds from the mercaptan oxidation process can be oxidized, preferably in the presence of a catalyst. The oxidation reaction products constitute an abundant source of ODSO compounds, sulfoxides, sulfonates, sulfinates and sulfones.

The ODSO stream so-produced contains ODSO compounds as disclosed in U.S. Pat. Nos. 10,781,168 and 11,111,212 as compositions (such as a solvent), in U.S. Pat. No. 10,793,782 as an aromatics extraction solvent, and in U.S. Pat. No. 10,927,318 as a lubricity additive, all of which are incorporated by reference herein in their entireties. In the event that a refiner has produced or has on hand an amount of DSO compounds that is in excess of foreseeable needs for these or other uses, the refiner may wish to dispose of the DSO compounds in order to clear a storage vessel and/or eliminate the product from inventory for tax reasons.

Thus, there is a clear and long-standing need to provide an efficient and economical process for the treatment of the large volumes of DSO by-products and their derivatives to effect and modify their properties in order to facilitate and simplify their environmentally acceptable disposal, and to utilize the modified products in an economically and environmentally friendly manner, and thereby enhance the value of this class of by-products to the refiner.

Despite the known ways to extract metal from catalyst materials, there remains a need in the art for improved leaching agent compositions and methods, in particular using DSO by-products in an economically and environmentally friendly manner. It is in regard to these and other problems in the art that the present disclosure is directed to provide a technical solution for improved leaching agent compositions and methods.

### SUMMARY OF THE DISCLOSURE

In certain embodiments, a leaching agent composition is provided. The leaching agent composition includes one or more oxidized disulfide oil (ODSO) compounds, and is used to recover one or more metals from catalyst materials.

In certain embodiments, a method of recovering metal from catalyst material comprising one or more metals from catalyst materials is provided. The catalyst material containing metal is provided and contacted with a leaching agent composition including one or more oxidized disulfide oil (ODSO) compounds. At least a portion of metal contained in the catalyst material is extracted into the leaching agent composition.

In certain embodiments the metal contained in the catalyst material comprises catalytically active metal. In some embodiments the catalytically active metal is one or more metals selected from Periodic Table IUPAC Groups 6, 7, 9 and 10. In some embodiments a catalytically active catalytically active metal may be one or more of Co, Ni, Mo and W. In some embodiments a catalytically active metal is one or more rare earth metals. In some embodiments a catalytically active metal is one or more of Pt, Pd, Ir and Rh. In certain embodiments the metal contained in the catalyst material comprises contaminant metal contained on the catalyst material due to prior use of the catalyst material. In some embodiments the contaminant metal is one or more of Ni, V and Fe. In some embodiments the contaminant metal is metal contained in a hydrocarbon feed that has been treated by contact with the catalyst material. In certain embodiments the metal contained in the catalyst material comprises catalytically active metal and contaminant metal contained on the catalyst material due to prior use of the catalyst material.

In certain embodiments the leaching agent composition further comprises one or more additional leaching compound(s). In some embodiments the additional leaching compound(s) include one or more of hydrochloric acid, sulfuric acid and nitric acid. In some embodiments the additional leaching compound(s) include one or more of oxalic acid, lactic acid, citric acid, glycolic acid, phthalic acid, malonic acid, succinic acid, salicylic acid and tartaric acid.

In certain embodiments the one or more ODSO compounds are derived from oxidation of disulfide oil compounds present in an effluent refinery hydrocarbon stream recovered following catalytic oxidation of mercaptans present in a mercaptan-containing hydrocarbon stream. In certain embodiments: the one or more ODSO compounds comprise water-soluble ODSO compounds having 3 or more oxygen atoms. In certain embodiments: the one or more ODSO compounds are selected from the group consisting of (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR); the ODSO compounds include two or more compounds selected from the group consisting of (R—SO—S—R′), (R—SOO—S—R), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR); the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH) and (X—SOO—OR); the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH) and (X—SOO—OR); the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH); or the ODSO compounds have 3 or more oxygen atoms and include two or more compounds selected from the group consisting of (R—SOO—SO—R′), (R—SOO—SOO—R′), (R′ SO—SOO—OH), (R—SOO—SOO—OH), (R—SO—SO—OH), (R—SOO—SO—OH); wherein R and R′ are alkyl or aryl groups comprising 1-10 carbon atoms and wherein X denotes esters and is (R—SO) or (R—SOO).

In certain embodiments the one or more ODSO compounds are contained in a pH-modified water-soluble ODSO composition comprising an aqueous mixture of one or more water-soluble ODSO compounds and an effective amount of an alkaline agent, and wherein the leaching agent composition is acidic. In certain embodiments the one or more ODSO compounds are contained in a supernatant from a prior synthesis that utilized water-soluble ODSO as a component, and wherein the leaching agent composition is acidic.

Any combinations of the various embodiments and implementations disclosed herein can be used. These and other aspects and features can be appreciated from the following description of certain embodiments and the accompanying drawings and claims.

### BRIEF DESCRIPTION OF DRAWINGS

The following detailed description of specific embodiments of the present disclosure can be best understood when read in conjunction with the following drawings, where like structure is indicated with like reference numerals and in which:

FIG. 1 is a simplified schematic diagram of a generalized version of a conventional mercaptan oxidation or MEROX process for the liquid-liquid extraction of a mercaptan containing hydrocarbon stream.

FIG. 2 is a simplified schematic diagram of a generalized version of an enhanced mercaptan oxidation or E-MEROX process.

FIGS. 3A and 3B are nuclear magnetic resonance spectra of the ODSO fraction used. in examples herein.

### DETAILED DESCRIPTION

Disclosed are leaching agent compositions and methods of using a leaching acid composition to remove metals from catalyst material. The leaching agent composition comprises ODSO. Active phase metals and/or contaminant metals are removed from catalyst material, for example after typical oil removal and drying steps. The removed metals include: active phase metals including but not limited to Co, Mo, Ni and/or W; and/or contaminant metals such including but not limited to Ni, V and/or Fe. Advantageously, ODSO, which is derived from a refinery waste stream, is used to replace and/or supplement commonly used leaching acids to remove metals used in catalyst preparation or contaminant metals deposited onto the catalyst surface. The removed metals may be recovered and separated into individual metals, or maintained as a mixture of metals. The recovered metals may be used in metal alloys or used in catalyst preparation.

Example embodiments of the present disclosure are directed to a leaching agent composition, or a leaching acid, comprising one or more ODSO compounds as acids. The leaching acid mixture has a pH of less than 7, less than or equal to 4, or less than or equal to 1. The leaching acid can be a mixture that comprises two or more ODSO compounds. In the description herein, the terms “oxidized disulfide oil”, “ODSO”, “ODSO mixture” and “ODSO compound(s)” may be used interchangeably for convenience. As used herein, the abbreviations of oxidized disulfide oils (“ODSO”) and disulfide oils (“DSO”) will be understood to refer to the singular and plural forms, which may also appear as “DSO compounds” and “ODSO compounds,” and each form may be used interchangeably. In certain instances, a singular ODSO compound may also be referenced.

As used in this disclosure, a “catalyst” refers to any substance which increases the rate of a specific chemical reaction. Catalysts described in this disclosure may be utilized to promote various reactions, such as, but not limited to, treating for removal of contaminants such as desulfurization and/or denitrogenation and/or demetallization, cracking, or reforming. “Fresh catalyst” refers to catalyst that has not contacted a feed for reaction. Catalysts including fresh catalyst include but are not limited to those having one or more active phase metals. Active phase metals are typically selected based on the use of the catalyst. In certain embodiments active phase metals include one or more metals selected from Periodic Table IUPAC Groups 6, 7, 9 and 10. in certain embodiments active phase metals include one or more metals selected from Co, Ni, Mo and W. In certain embodiments active phase metals include one or more noble metals selected from Pt, Pd, Ir and Rh. The active phase metals are deposited on a support such as alumina, silica-alumina, silica, natural zeolites, synthetic zeolites, and combinations comprising one or more of the above supports.

As used in this disclosure, the term “spent catalyst” refers to catalyst that has been contacted with a hydrocarbon feed, for example including but not limited to hydroprocessing (which may include one or more of hydrocracking, hydrotreating, hydrodesulfurization, hydrodenitrogenation, hydrodemetallization, and/or hydrogenation), catalytic reforming, or fluidized catalytic cracking. The spent catalyst may have coke deposited on the catalyst, and may include partially coked catalyst as well as fully coked catalysts; the amount of coke deposited on the spent catalyst may be greater than the amount of coke remaining on the rejuvenated catalyst following rejuvenation and/or the regenerated catalyst following regeneration. The spent catalyst may also have contaminant metals deposited on the catalyst, generally corresponding to the metal(s) contained in a hydrocarbon feed that has been treated by the catalyst material, wherein contaminant metals include for example one or more of Ni, V and Fe.

As used in this disclosure, the term “rejuvenated catalyst” refers to catalyst that has been rejuvenated by one or more treatment steps including contacting with a leaching agent composition. The rejuvenated catalyst may have less coke compared to spent catalyst, and more coke compared to fresh catalyst that has not contacted a hydrocarbon feed. The rejuvenated catalyst may have less contaminant metals compared to spent catalyst, and more contaminant metals compared to fresh catalyst. Further, the rejuvenated catalyst may have greater catalytic activity compared to spent catalyst, and lesser catalytic activity compared to fresh catalyst.

As used in this disclosure, the term “regenerated catalyst” refers to catalyst that has been regenerated to by high temperature treatment, for example combustion, to remove at least a portion of the coke from the catalyst to restore at least a portion of the catalytic activity of the catalyst, or both. In some embodiments a rejuvenated catalyst may be subject to regeneration to provide regenerated catalyst. The regenerated catalyst may have less coke compared to spent catalyst and/or rejuvenated catalyst, and may have greater catalytic activity compared to spent catalyst and/or rejuvenated catalyst. The regenerated catalyst may have more coke and lesser catalytic activity compared to fresh catalyst.

The present disclosure is directed to a leaching agent composition and method of removing metal from catalyst material using the leaching agent composition. A leaching agent composition includes an ODSO acid or ODSO acid mixture. The ODSO is used in place of, or in conjunction with, one or more additional acids. The ODSO acid or ODSO acid mixture has a pH of less than 7, less than or equal to 4, or less than or equal to 1. The acid can be a mixture that comprises two or more ODSO compounds. A suitable acid or acid mixture is disclosed, for example, in co-pending and commonly owned U.S. patent application Ser. No. 17/720,702 Apr. 14, 2022, entitled “ODSO Acid Medium, ODSO Acid Mixture Medium, and Uses Thereof,” which is incorporated by reference herein in its entirety.

Embodiments of the present disclosure are directed to a leaching agent composition comprising, consisting of or consisting essentially of ODSO compounds. In certain embodiments a leaching agent composition comprises, consists of or consists essentially of one or more polar water-soluble ODSO compounds. In certain embodiments the ODSO compounds or water-soluble ODSO compounds are derived from oxidation of disulfide oil compounds present in an effluent refinery hydrocarbon stream recovered following catalytic oxidation of mercaptans present in a mercaptan-containing hydrocarbon stream.

In certain embodiments, a leaching agent composition comprises, consists of or consists essentially of ODSO compounds that are contained in a mixture, undiluted from controlled catalytic oxidation of DSO, and includes about 50-100, 75-100, 90-100 percent by mass of one or more ODSO compounds (referred to herein for convenience as a “neat” ODSO acid medium).

In certain embodiments, a leaching agent composition comprises, consists of or consists essentially of a neat ODSO acid medium that is diluted with water, for instance wherein the neat ODSO acid medium comprises 0.1-99.9, 1-99.9, 5-99.9, 10-99.9, 25-99.9, 50-99.9, 0.1-90, 1-90, 5-90, 10-90, 25-90, 50-90, 0.1-75, 1-75, 5-75, 10-75, 25-75 or 50-75 percent by mass of the overall solution of acid medium.

In certain embodiments, a leaching agent composition comprises, consists of or consists essentially of a neat ODSO acid medium or a diluted ODSO acid medium, mixed with one or more additional acidic components suitable for leaching of metals from catalyst (leaching acid), including inorganic acids and/or organic acids. Inorganic acids suitable as an additional leaching acid in an embodiment of a leaching agent composition herein include one or more of hydrochloric acid, sulfuric acid and nitric acid. Organic acids suitable as a leaching acid in an embodiment of a leaching agent composition herein include one or more of oxalic acid, lactic acid, citric acid, glycolic acid, phthalic acid, malonic acid, succinic acid, salicylic acid and tartaric acid. The additional acidic component(s) can be provided in pure (100 percent by mass acid) or in aqueous diluted form, for example from a solution of 0.1-99.9 percent by mass, which is combined with the neat or diluted ODSO acid medium to form a leaching agent composition herein.

In certain embodiments leaching agent composition includes an acidic pH-modified ODSO composition. Such a pH-modified ODSO composition is disclosed in U.S. patent application Ser. Nos. 17/850,158 and 17/850,115 filed on Jun. 27, 2022. incorporated by reference herein. The pH-modified ODSO composition comprises an acidic ODSO composition and an alkaline agent in an amount to retain an acidic pH of less than about 7. In certain embodiments, the alkaline agent is selected from the group consisting of sodium hydroxide, calcium hydroxide, lithium hydroxide, strontium hydroxide, barium hydroxide, potassium hydroxide, cesium hydroxide, rubidium hydroxide, ammonia, ammonium hydroxide, lithium hydroxide, zinc hydroxide, trimethylamine, pyridine, beryllium hydroxide, magnesium hydroxide, and combinations of one of the foregoing alkaline agents. In certain embodiments, the alkaline agent is selected from the group consisting of sodium hydroxide, potassium hydroxide, rubidium hydroxide, lithium hydroxide, cesium hydroxide, and combinations of one of the foregoing alkaline agents.

In certain embodiments leaching agent composition includes supernatant from a prior synthesis that utilized ODSO, wherein the supernatant is acidic. Such a process is disclosed. in U.S. patent application Ser. No. 17/850,285 filed on Jun. 27, 2022, incorporated by reference herein. In such a process, a first synthesis of a first material is carried out using ODSO as a component (as-is, or as a pH modified composition). All or a portion of a precipitate is separated from a supernatant, and that supernatant from an ODSO synthesis is used as an ODSO component herein.

There are various processes for extraction of metals, for purposes of reclaiming the metals and/or for restoring catalytic activity by removing contaminant metals, include leaching by acidic and/or basic solutions, by ammonium or ammonium salts, by bio-leaching with microorganisms, by low temperature heat treatment (roasting), by sodium or potassium salts, by chlorination or by recovering metals electrolytically. In the process herein, acid leaching is carried out using the leaching agent composition comprising ODSO, optionally in combination with one or more leaching acids as described herein, whereby metal contained in the catalyst material is extracted into the leaching agent composition. In certain embodiments, the leaching agent composition further comprises an oxidizing agent to facilitate extraction, for example, one or more of water, ferric nitrate and aluminum nitrate.

Metals that are removed can be recovered for further use. For example, recovered metals may be separated from the leaching agent composition by precipitation. In embodiment in which metals are not isolated, they can be useful in metal alloys. Metals in solution can be isolated by selective precipitation, for example at different pHs and/or with different agents and/or by extraction agents such as oximes and beta-diketone. The recovery can occur in one or more steps, for example, to recover one or more types of metals in separate steps. Recovered metals can be used as-is or isolated. The recovered metals, as a mixture or isolated, may be used in metal alloys or catalyst preparation.

In certain embodiments, following removal of metals, all or a portion of the leaching acid composition can be recycled back to the leaching step. In certain embodiments, all or a portion of the leaching acid composition can be used in a subsequent process including but not limited to those disclosed in: U.S. Pat. No. 10,781,168 granted on Sep. 22, 2020 and 11,111,212 granted on Sep. 7, 2021, as compositions (such as a solvent); U.S. Pat. No. 10,793,782, granted on Oct. 6, 2020, as an aromatics extraction solvent; U.S. Pat. No. 10,927,318 granted on Feb. 23, 2021, as a lubricity additive; U.S. Pat. No. 10,995,278 granted on May 4, 2021, as an additive in delayed coking; U.S. Pat. No. 11,124,713 granted on Sep. 21, 2021, as an additive in fluidized catalytic cracking; U.S. Pat. No. 11,459,513 granted on Oct. 4, 2022, as a steam cracking additive; U.S. patent application Ser. No. 17/347,125 filed on Jun. 14, 2021, as a component in manufacture of mesoporous silica; U.S. patent application Ser. No. 17/493,201 filed on Oct. 4, 2021, as a component in manufacture of amorphous silica alumina; U.S. patent application Ser. No. 17/493,206 filed on Oct. 4, 2021, as a component in manufacture of ZSM-5 zeolite; U.S. patent application Ser. No. 17/719,848 filed on Apr. 13, 2022, as a component in manufacture of co-crystallized zeolite beta and zeolite mordenite; U.S. patent application Ser. No. 17/719,926 filed on Apr. 13, 2022, as a component in manufacture of co-crystallized pentasil zeolite and zeolite mordenite; U.S. patent application Ser. No. 17/719,972 filed on Apr. 13, 2022, as a component in manufacture of zeolite beta; U.S. patent application Ser. No. 17/720,012 filed on Apr. 13, 2022, as a component in manufacture of zeolite mordenite; U.S. patent application Ser. No. 17/720,072 filed on Apr. 13, 2022, as a component in manufacture of faujasite zeolite including zeolite Y; U.S. patent application Ser. No. 17/720,108 filed on Apr. 13, 2022, as a component to tailor zeolite silica-to-alumina ratio; U.S. patent application Ser. No. 17/720,123 filed on Apr. 13, 2022, as a component in manufacture of low silica MFI framework zeolite; U.S. patent application Ser. No. 17/850,115 filed on Jun. 27, 2022, as a component for zeolite synthesis after neutralizing with an alkaline agent; U.S. patent application Ser. Nos. 17/850,158 and 17/850,219 both filed on Jun. 27, 2022, as a component in a neutralized ODSO composition; U.S. patent application Ser. No. 17/850,285 filed on Jun. 27, 2022, as a component in the synthesis of zeolite where supernatant is recycled for subsequent synthesis; U.S. patent application Ser. No. 17/720,434 filed on Apr. 14, 2022, as an active component carrier composition; U.S. patent application Ser. Nos. 17/689,009 filed on Mar. 8, 2022 and 17/744,805 filed on May 16 , 2022, as a peptization agent; all of which are incorporated by reference herein in their entireties.

The catalyst material is treated as is known in the art regarding the steps to remove metals, generally by contacting the catalyst material with the leaching agent composition under effective conditions and for an effective time for leaching of metals in the catalyst material. In certain embodiments, contacting the catalyst material with the leaching agent may occur at a leaching agent to catalyst weight ratio in the range of about 1:1-3:1, at a temperature of about 20-80° C., and at a contact time of about 10-120 minutes a stirring speed of about 1-20 rpm.

In certain embodiments, treating of the catalyst material in the process herein is by catalyst rejuvenation, which generally includes solvent washing and acid washing using the leaching agent composition herein to remove undesired metals. In certain embodiments catalyst rejuvenation generally includes solvent washing, acid washing using the leaching agent composition herein, and water washing to remove undesired metals. In certain embodiments, coke is removed during the steps of catalyst rejuvenation. In certain embodiments, an insufficient amount of coke is removed during the steps for catalyst rejuvenation, and the resulting rejuvenated catalyst is subjected to catalyst regeneration to remove coke and produce rejuvenated/regenerated catalyst particles.

In certain embodiments, solvent washing can occur at a solvent:catalyst weight ratio in the range of about 1:1-3:1, at a catalyst temperature of about 35-80° C., for a contact time of about 60-120 minutes, and stirring at a speed in the range of about 1-20 rpm. In certain embodiments, acid washing can occur at a leaching agent:catalyst weight ratio in the range of about 1:1-3:1, a contact time of about 60-120 minutes a stirring speed of about 1-20 rpm. Water washing can occur for a similar time range and stirring speed as solvent and acid washing. Acid leaching removes targeted contaminant metals such as nickel and vanadium compounds from the spent catalyst. The acid-leached spent catalyst is typically subjected to water washing to remove residual acid solution.

In certain embodiments, the processes herein can be carried out by contacting the catalyst material multiple times with the leaching acid composition which generally may increase metal removal efficacy. In addition, metal removal efficacy may be increased with increased residence time. In certain embodiments, metal removal efficacy in the processes herein can be in the range of about 10-99, 10-95, 10-90, 10-80, 20-99, 20-95, 20-90 or 20-80 wt %, relative to the mass of metals in the catalyst material subjected to treatment with the herein leaching acid composition.

For example, a catalyst rejuvenation system may include a vessel having inlet and outlet openings for the catalyst and washing liquids, and is arranged to facilitate successive solvent washing, water washings, and acid treatment steps. A polar organic solvent which is both oil soluble and water soluble, such as acetone or other similar organic solvent liquid, is used in the solvent liquid washing, followed by water washing the substantially oil-free catalyst to remove the solvent without requiring any gas drying step. Further process steps include acid treating the oil-free catalyst with a leaching agent composition described herein. In certain embodiments acid treatment is for removal of contaminant metals such as nickel and vanadium compounds from the spent catalyst. The acid-treated catalyst is water washed to remove residual acid solution. Since the polar solvent and acid liquids used for the washing and treatment steps are soluble in both oil and water, this catalyst rejuvenation process can utilize a two-step water washing procedure for the solvent washed and the acid treated catalyst, after which the solvent and the acid liquids can be recovered by distillation for reuse in the rejuvenation process. In certain optional embodiments a catalyst rejuvenation system also includes suitable unit operation to heat and oxidize the solvent-washed and acid-treated during contact with an oxygen-containing gas such as inert gas/air or steam/air mixture at appropriate high temperature and time duration conditions to burn off and remove substantially all coke deposits from the catalyst.

In certain embodiments, spent catalyst material is rejuvenated by solvent washing and acid treatment steps, in which the spent catalyst is washed, for instance, with naphtha or toluene solvent to remove retained heavy oil. The washed catalyst material is heated to remove the retained solvent, and then water washed to fill the catalyst pores. The water washed catalyst material is then passed to an acid treatment vessel and contacted with a leaching agent composition. The acid-treated catalyst is washed with water to remove the retained acid, and then the material is dried and oxidized at desired high temperature to burn off carbon deposits. In certain embodiments, spent catalyst material is rejuvenated in a single vessel, utilizing successive solvent washing, vacuum drying, acid treatment with the leaching agent composition herein, and gas drying steps.

Following catalyst rejuvenation as described above, the rejuvenated spent catalyst particles still include accumulated coke on the surface. Coke is the term used for large carbonaceous species often containing polyaromatic rings, typically including heteroatoms such as sulfur and nitrogen. These species fully or partially cover the active sites on the catalyst particles. These carbonaceous species also block the pores of the catalyst particles. This accumulated coke is partially or fully removed by catalyst regeneration, which is a combustion process used to restore activity to the catalyst particles by combustion of coke. Restoration of the catalyst particles can be substantially complete depending upon the extent of coke build-up and/or regeneration conditions. For example, using an oxidizing atmosphere, such as typically air or an oxygen enriched gas, at a temperature in the range of about 400-900, 450-800 or 480-600° C., the partial catalyst regeneration process can remove the coke on the catalyst by burning the carbonaceous species and the acid removes other residual contaminants while active phase metals are still protected by the coke remaining on the catalyst. In a typical regeneration process, a full combustion process is carried out producing CO₂ as a by-product, in contrast to gasification which is a partial combustion process producing syngas H₂+CO. By using an oxidizing atmosphere, the catalyst regeneration process can remove the coke on the catalyst by burning the carbonaceous species. In an embodiment in which acid leaching is selective, other residual contaminants are removed. In an embodiment in which acid leaching is selective, regeneration may convert a sulfide phase to an oxide phase.

In certain embodiments, the one or more ODSO compounds that are contained in reaction products, or a fraction of reaction products, derived from controlled catalytic oxidation of disulfide. For example, as described above and in commonly owned U.S. Pat. No. 10,807,947 which is incorporated by reference herein in its entirety, a controlled catalytic oxidation of MEROX process by-products DSO can be carried out. The resulting oxidized effluents contain ODSO. As disclosed in U.S. Pat. No. 10,807,947, the by-product DSO compounds from the mercaptan oxidation process can be oxidized, typically in the presence of a catalyst. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. In certain embodiments herein, a catalyst is used in the oxidation process.

In certain embodiments ODSO is obtained from controlled catalytic oxidation of disulfide oils from mercaptan oxidation processes. The effluents from controlled catalytic oxidation of disulfide oils from mercaptan oxidation processes includes ODSO compounds and in certain embodiments DSO compounds that were unconverted in the oxidation process. In certain embodiments this effluent contains water-soluble compounds and water-insoluble compounds. The effluent contains at least one ODSO compound, or a mixture of two or more ODSO compounds, selected from the group consisting of compounds having the general formula (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR). In certain embodiments, in the above formulae R and R′ are alkyl or aryl groups comprising 1-10 carbon atoms. Further, X denotes esters and is (R—SO) or (R—SOO), with R as defined above. It will be understood that since the source of the DSO is a refinery feedstream, the R and X substituents vary, e.g., methyl and ethyl subgroups, and the number of sulfur atoms, S, in the as-received feedstream to oxidation can extend to 3, for example, trisulfide compounds.

In certain embodiments herein, water-soluble compounds and water-insoluble compounds are separated from one another, and the ODSO used herein comprises all or a portion of the water-soluble compounds separated from the total effluents from oxidation of disulfide oils from mercaptan oxidation processes. For example, the different phases can be separated by decantation or partitioning with a separating funnel, separation drum, by decantation, or any other known apparatus or process for separating two immiscible phases from one another. In certain embodiments, the water-soluble and water-insoluble components can be separated by distillation as they have different boiling point ranges. It is understood that there will be crossover of the water-soluble and water-insoluble components in each fraction due to solubility of components, typically in the ppmw range (for instance, about 1-10,000, 1-1,000, 1-500 or 1-200 ppmw). In certain embodiments, contaminants from each phase can be removed, for example by stripping or adsorption.

In certain embodiments ODSO used herein comprises, consists of or consists essentially of at least one ODSO compound that is selected from the group consisting of compounds having the general formula (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR). In certain embodiments ODSO used herein comprises, consists of or consists essentially of a mixture or two or more ODSO compounds having the general formula (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR). In certain embodiments ODSO used herein comprises, consists of or consists essentially of at least one ODSO compound having 3 or more oxygen atoms that is selected from the group consisting of compounds having the general formula (R—SOO—SO—R′), (R—SOO—SOO—R′), (R—SO—SOO—OH), (R—SOO—SOO—OH), (R—SOO—SO—OH), (X—SO—OR) and (X—SOO—OR). In certain embodiments ODSO used herein comprises, consists of or consists essentially of a mixture or two or more ODSO compounds having 3 or more oxygen atoms, that is selected from the group consisting of compounds having the general formula (R—SOO—SO—R′), (R—SOO—SOO—R′), (R—SO—SOO—OH), (R—SOO—SOO—OH), (R—SOO—SO—OH), (X—SO—OR) and (X—SOO—OR). In certain embodiments ODSO used herein comprises, consists of or consists essentially of ODSO compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), and mixtures thereof. In certain embodiments, in the above formulae R and R′ are alkyl or aryl groups comprising 1-10 carbon atoms. Further, X denotes esters and is (R—SO) or (R—SOO) with R as defined above. In certain embodiments, the R and R′ are methyl and/or ethyl groups. In certain embodiments, the water-soluble ODSO compound(s) used herein have 1 to 20 carbon atoms.

In certain embodiments, the ODSO compounds used herein comprise, consist of or consist essentially of ODSO compounds having an average density greater than about 1.0 g/cc. In certain embodiments, the ODSO compounds used herein comprise, consist of or consist essentially of ODSO compounds having an average boiling point greater than about 80° C. In certain embodiments, the ODSO compounds used herein comprise, consist of or consist essentially of ODSO compounds having a dielectric constant that is less than or equal to 100 at 0° C.

Table 1 includes examples of ODSO compounds. ODSO compounds that contain 1 and 2 oxygen atoms are non-polar and water-insoluble. ODSO compounds that contain 3 or more oxygen atoms are water-soluble. The production of either polar or non-polar ODSO compounds is in part dependent on the reaction conditions during the oxidation process. In certain embodiments the identified ODSO compounds are obtained from a water-soluble fraction of the effluents from oxidation of DSO obtained from MEROX by-products. The ODSO compounds that contain 3 or more oxygen atoms are water-soluble over effectively all concentrations, for instance, with some minor amount of acceptable tolerance for carry over components from the effluent stream and in the water insoluble fraction with 2 oxygen atoms of no more than about 1, 3 or 5 mass percent.

In certain embodiments the ODSO compounds contained in an oxidation effluent stream that is derived from controlled catalytic oxidation of MEROX process by-products, DSO compounds, as disclosed in U.S. Pat. Nos. 10,807,947 and 10,781,168 and as incorporated herein by reference above.

As noted above, the designation “MEROX” originates from the function of the process itself, that is, the conversion of mercaptans by oxidation. The MEROX process in all of its applications is based on the ability of an organometallic catalyst in a basic environment, such as a caustic, to accelerate the oxidation of mercaptans to disulfides at near ambient temperatures and pressures. The overall reaction can be expressed as follows:

RSH+¼O₂→½RSSR+½H₂O (1)

where R is a hydrocarbon chain that may be straight, branched, or cyclic, and the chains can be saturated or unsaturated. In most petroleum fractions, there will be a mixture of mercaptans so that the R can have 1, 2, 3 and up to 10 or more carbon atoms in the chain. This variable chain length is indicated by R and R′ in the reaction. The reaction is then written:

2R′SH+2RSH+O₂→2R′SSR+2H₂O (2)

This reaction occurs spontaneously whenever any sour mercaptan-bearing distillate is exposed to atmospheric oxygen, but proceeds at a very slow rate. In addition, the catalyzed reaction (1) set forth above requires the presence of an alkali caustic solution, such as aqueous sodium hydroxide. The mercaptan oxidation proceeds at an economically practical rate at moderate refinery downstream temperatures.

The MEROX process can be conducted on both liquid streams and on combined gaseous and liquid streams. In the case of liquid streams, the mercaptans are converted directly to disulfides which remain in the product so that there is no reduction in total sulfur content of the effluent stream. The MEROX process typically utilizes a fixed bed reactor system for liquid streams and is normally employed with charge stocks having end points above 135° C.-150° C. Mercaptans are converted to disulfides in the fixed bed reactor system over a catalyst, for example, an activated charcoal impregnated with the MEROX reagent, and wetted with caustic solution. Air is injected into the hydrocarbon feedstream ahead of the reactor and in passing through the catalyst-impregnated bed, the mercaptans in the feed are oxidized to disulfides. The disulfides are substantially insoluble in the caustic and remain in the hydrocarbon phase. Post treatment is required to remove undesirable by-products resulting from known side reactions such as the neutralization of H₂S, the oxidation of phenolic compounds, entrained caustic, and others.

The vapor pressures of disulfides are relatively low compared to those of mercaptans, so that their presence is much less objectionable from the standpoint of odor; however, they are not environmentally acceptable due to their sulfur content and their disposal can be problematical.

In the case of mixed gas and liquid streams, extraction is applied to both phases of the hydrocarbon streams. The degree of completeness of the mercaptan extraction depends upon the solubility of the mercaptans in the alkaline solution, which is a function of the molecular weight of the individual mercaptans, the extent of the branching of the mercaptan molecules, the concentration of the caustic soda and the temperature of the system. Thereafter, the resulting DSO compounds are separated and the caustic solution is regenerated by oxidation with air in the presence of the catalyst and reused.

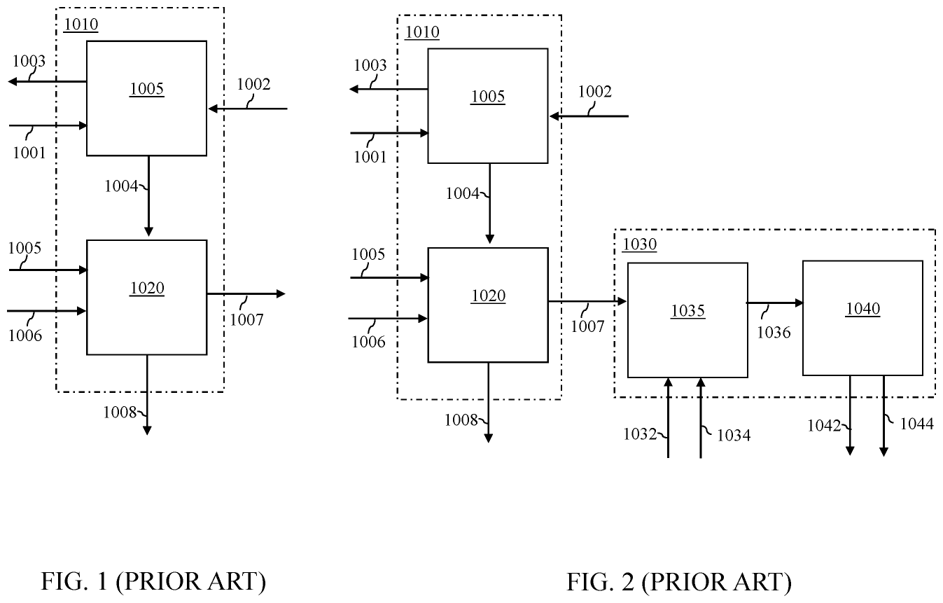

Referring to the attached drawings, FIG. 1 is a simplified schematic of a generalized version of a conventional MEROX process employing liquid-liquid extraction for removing sulfur compounds. A MEROX unit 1010, is provided for treating a mercaptan containing hydrocarbon stream 1001. In some embodiments, the mercaptan containing hydrocarbon stream 1001 is LPG, propane, butane, light naphtha, kerosene, jet fuel, or a mixture thereof. The process generally includes the steps of: introducing the hydrocarbon stream 1001 with a homogeneous catalyst into an extraction vessel 1005 containing a caustic solution 1002. In some embodiments, the catalyst is a homogeneous cobalt-based catalyst; passing the hydrocarbon catalyst stream in counter-current flow through the extraction section of the extraction 1005 vessel in which the extraction section includes one or more liquid-liquid contacting extraction decks or trays (not shown) for the catalyzed reaction with the circulating caustic solution to convert the mercaptans to water-soluble alkali metal alkane thiolate compounds; withdrawing a hydrocarbon product stream 1003 that is free or substantially free of mercaptans from the extraction vessel 1005, for instance, having no more than about 1000, 100, 10 or 1 ppmw mercaptans; recovering a combined spent caustic and alkali metal alkane thiolate stream 1004 from the extraction vessel 1005; subjecting the spent caustic and alkali metal alkane thiolate stream 1004 to catalyzed wet air oxidation in a reactor 1020 into which is introduced catalyst 1005 and air 1006 to provide the regenerated spent caustic 1008 and convert the alkali metal alkane thiolate compounds to disulfide oils; and recovering a by-product stream 1007 of DSO compounds and a minor proportion of other sulfides such as mono-sulfides and tri-sulfides. The effluents of the wet air oxidation step in the MEROX process can comprise a minor proportion of sulfides and a major proportion of disulfide oils. As is known to those skilled in the art, the composition of this effluent stream depends on the effectiveness of the MEROX process, and sulfides are assumed to be carried-over material. A variety of catalysts have been developed for the commercial practice of the process. The efficiency of the MEROX process is also a function of the amount of H₂S present in the stream. It is a common refinery practice to install a prewashing step for H₂S removal.

An enhanced MEROX process (“E-MEROX”) is a modified MEROX process where an additional step is added, in which DSO compounds are oxidized with an oxidant in the presence of a catalyst to produce a mixture of ODSO compounds. The by-product DSO compounds from the mercaptan oxidation process are oxidized, in some embodiments in the presence of a catalyst, and constitute an abundant source of ODSO compounds that are sulfoxides, sulfonates, sulfinates, sulfones and their corresponding di-sulfur mixtures. The disulfide oils having the general formula RSSR′ (wherein R and R′ can be the same or different and can have 1, 2, 3 and up to 10 or more carbon atoms) can be oxidized without a catalyst or in the presence of one or more catalysts to produce a mixture of ODSO compounds. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. If a catalyst is used in the oxidation of the disulfide oils having the general formula RSSR′ to produce the ODSO compounds, it can be a heterogeneous or homogeneous oxidation catalyst. The oxidation catalyst can be selected from one or more heterogeneous or homogeneous catalyst comprising metals from the IUPAC Groups 4-12 of the Periodic Table. In certain embodiments oxidation catalyst are metals or metal compounds containing one or more transition metals. In certain embodiments oxidation catalyst are metals or metal compounds containing one or more metals selected from the group consisting of Ti, V, Mn, Co, Fe, Cr, Cu, Zn, W and Mo. The catalyst can be a homogeneous water-soluble compound that is a transition metal containing an active species selected from the group consisting of Mo (VI), W (VI), V (V), Ti (IV), and combinations thereof. In certain embodiments, suitable homogeneous catalysts include molybdenum acetylacetonate, bis(acetylacetonate) dioxomolybdenum, molybdenum naphthenate, sodium tungstate, molybdenum hexacarbonyl, tungsten hexacarbonyl, sodium tungstate and vanadium pentoxide. An exemplary catalyst for the controlled catalytic oxidation of MEROX process by-products DSO is sodium tungstate, Na₂WO₄·2H₂O. In certain embodiments, suitable heterogeneous catalysts include Ti, V, Mn, Co, Fe, Cr, W, Mo, and combinations thereof deposited on a support such as alumina, silica-alumina, silica, natural zeolites, synthetic zeolites, and combinations comprising one or more of the above supports.

The oxidation of DSO typically is carried out in an oxidation vessel selected from one or more of a fixed-bed reactor, an ebullated bed reactor, a slurry bed reactor, a moving bed reactor, a continuous stirred tank reactor, and a tubular reactor. The ODSO compounds produced in the E-MEROX process generally comprise two phases: a water-soluble phase and water-insoluble phase, and can be separated into the aqueous phase containing water-soluble ODSO compounds and a non-aqueous phase containing water-insoluble ODSO compounds. The E-MEROX process can be tuned depending on the desired ratio of water-soluble to water-insoluble compounds presented in the product ODSO mixture. Partial oxidation of DSO compounds results in a higher relative amount of water-insoluble ODSO compounds present in the ODSO product and a near or almost complete oxidation of DSO compounds results in a higher relative amount of water-soluble ODSO present in the ODSO product. Details of the ODSO compositions are disclosed in U.S. Pat. No. 10,781,168, which is incorporated herein by reference above.

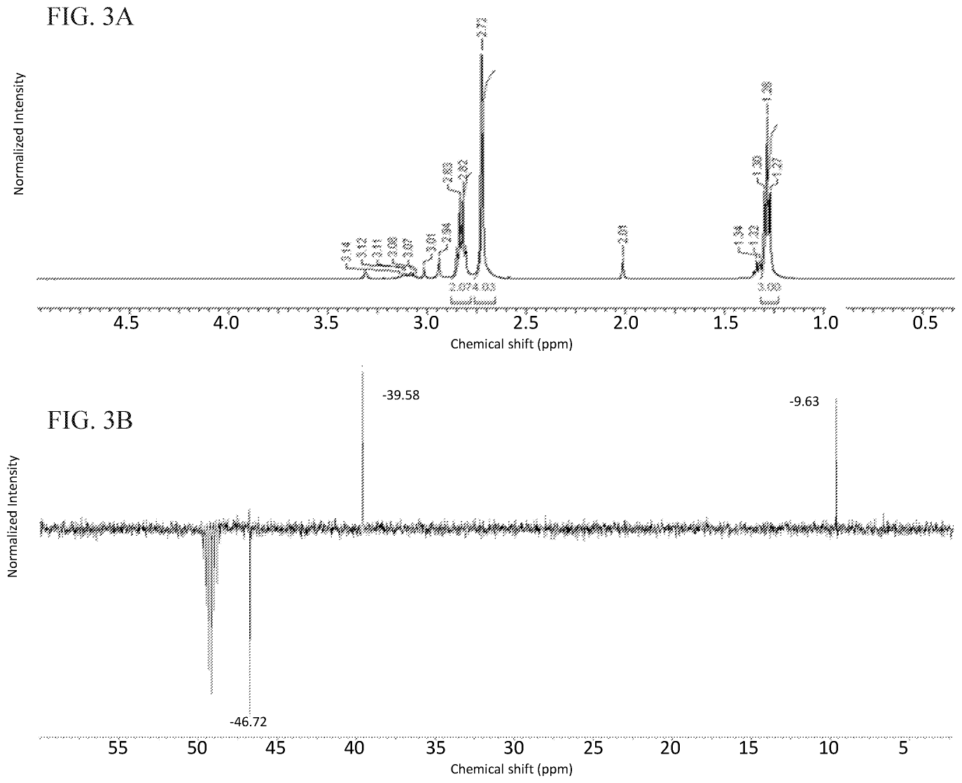

FIG. 2 is a simplified schematic of an E-MEROX process that includes E-MEROX unit 1030. The MEROX unit 1010 unit operates similarly as in FIG. 2, with similar references numbers representing similar units/feeds. In FIG. 3, the effluent stream 1007 from the generalized MEROX unit of FIG. 2 is treated. It will be understood that the processing of the mercaptan containing hydrocarbon stream of FIG. 2 is illustrative only and that separate streams of the products, and combined or separate streams of other mixed and longer chain products can be the subject of the process for the recovery and oxidation of DSO to produce ODSO compounds, that is the E-MEROX process. In order to practice the E-MEROX process, apparatus are added to recover the by-product DSO compounds from the MEROX process. In addition, a suitable reactor 1035 add into which the DSO compounds are introduced in the presence of a catalyst 1032 and an oxidant 1034 and subjecting the DSO compounds to a catalytic oxidation step to produce the mixed stream 1036 of water and ODSO compounds. A separation vessel 1040 is provided to separate the by-product 1044 from the ODSO compounds 1042.

The oxidation to produce OSDO can be carried out in a suitable oxidation reaction vessel operating at a pressure in the range from about 1-30, 1-10 or 1-3 bars. The oxidation to produce OSDO can be carried out at a temperature in the range from about 20-300, 20-150, 20-90, 45-300, 15-150 or 45-90° C. The molar feed ratio of oxidizing agent-to-mono-sulfur can be in the range of from about 1:1 to 100:1, 1:1 to 30:1 or 1:1 to 4:1. The residence time in the reaction vessel can be in the range of from about 5-180, 5-90, 5-30, 15-180, 15-90 or 5-30 minutes. In certain embodiments, oxidation of DSO is carried out in an environment without added water as a reagent. The by-products stream 1044 generally comprises wastewater when hydrogen peroxide is used as the oxidant. Alternatively, when other organic peroxides are used as the oxidant, the by-products stream 1044 generally comprises the alcohol of the peroxide used. For example, if butyl peroxide is used as the oxidant, the by-product alcohol 1044 is butanol.

In certain embodiments water-soluble ODSO compounds are passed to a fractionation zone (not shown) for recovery following their separation from the wastewater fraction. The fractionation zone can include a distillation unit. In certain embodiments, the distillation unit can be a flash distillation unit with no theoretical plates in order to obtain distillation cuts with larger overlaps with each other or, alternatively, on other embodiments, the distillation unit can be a flash distillation unit with at least 15 theoretical plates in order to have effective separation between cuts. In certain embodiments, the distillation unit can operate at atmospheric pressure and at a temperature in the range of from 100° C. to 225° C. In other embodiments, the fractionation can be carried out continuously under vacuum conditions. In those embodiments, fractionation occurs at reduced pressures and at their respective boiling temperatures. For example, at 350 mbar and 10 mbar, the temperature ranges are from 80° C. to 194° C. and 11° C. to 98° C., respectively. Following fractionation, the wastewater is sent to the wastewater pool (not shown) for conventional treatment prior to its disposal. The wastewater by-product fraction can contain a small amount of water-insoluble ODSO compounds, for example, in the range of from 1 ppmw to 10,000 ppmw. The wastewater by-product fraction can contain a small amount of water-soluble ODSO compounds, for example, in the range of from 1 ppmw to 50,000 ppmw, or 100 ppmw to 50,000 ppmw. In embodiments where alcohol is the by-product alcohol, the alcohol can be recovered and sold as a commodity product or added to fuels like gasoline. The alcohol by-product fraction can contain a small amount of water-insoluble ODSO compounds, for example, in the range of from 1 ppmw to 10,000 ppmw. The alcohol by-product fraction can contain a small amount of water-soluble ODSO compounds, for example, in the range of from 100 ppmw to 50,000 ppmw.

### Examples

The following examples illustrate one or more additional features of the present disclosure. In the following examples, an ODSO in various forms was used as a leaching agent composition. The Reference Example describes the source of the ODSO, and Examples 1 and 2 disclose use of the ODSO in various forms for removal of metal from catalyst material.

Reference Example: The ODSO mixture used in the Example below was produced as disclosed in U.S. Pat. No. 10,781,168, incorporated by reference above, and in particular the fraction referred to therein as Composition 2. Catalytic oxidation a hydrocarbon refinery feedstock having 98 mass percent of C₁ and C₂ disulfide oils was carried out. The oxidation of the DSO compounds was performed in batch mode under reflux at atmospheric pressure, that is, approximately 1.01 bar. The hydrogen peroxide oxidant was added at room temperature, that is, approximately 23° C. and produced an exothermic reaction. The molar ratio of oxidant-to-DSO compounds (calculated based upon mono-sulfur content) was 2.90. After the addition of the oxidant was complete, the reaction vessel temperature was set to reflux at 80° C. for approximately one hour after which the water-soluble ODSO was produced (referred to as Composition 2 herein and in U.S. Pat. No. 10,781,168) and isolated after the removal of water. The catalyst used in the oxidation of the DSO compounds was sodium tungstate. The Composition 2, referred to herein as “the selected water-soluble ODSO fraction,” was used. FIG. 3A is the experimental ¹H-NMR spectrum of the polar, water-soluble ODSO mixture that is the selected water-soluble ODSO fraction in the example herein. FIG. 3B is the experimental ¹³C-DEPT-135-NMR spectrum of the polar, water-soluble ODSO mixture that is the selected water-soluble ODSO fraction in the example herein. The selected water-soluble ODSO fraction was mixed with a CD₃OD solvent and the spectrum was taken at 25° C. Methyl carbons have a positive intensity while methylene carbons exhibit a negative intensity. The peaks in the 48-50 ppm region belong to carbon signals of the CD₃OD) solvent.

When comparing the experimental ¹³C-DEPT-135-NMR spectrum of FIG. 3B for the selected water-soluble ODSO fraction with a saved database of predicted spectra, it was found that a combination of the predicted alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) most closely corresponded to the experimental spectrum. This suggests that alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) are major compounds in the selected water-soluble ODSO fraction. It is clear from the NMR spectra shown in FIGS. 3A and 3B that the selected water-soluble ODSO fraction comprises a mixture of ODSO compounds that form the ODSO composition used in the present examples as a leaching acid.

Example 1: A leaching agent composition was provided using the water-soluble ODSO from the Reference Example (undiluted). A quantity of 20 cubic centimeters (cc) of the leaching agent composition was added to a round-bottom flask with a stirrer bar. The liquid was stirred with a magnetic stirrer and at room temperature. A quantity of 10 cc of catalyst containing Mo and Ni metals was added to the water-soluble ODSO. The mixture was stirred at room temperature for 1 hour. The stirring speed was adjusted to a sufficient level to agitate the extrudate particles in leaching agent composition. After one hour of reaction time, the catalyst was filtered from the leaching agent composition. The catalyst was placed in 1 liter of distilled water and stirred for 2 minutes. The catalyst particles were removed, dried at 110° C. The catalyst was analyzed for Mo and Ni and is presented in Table 2 as CAT1.

Example 3: A leaching agent composition was provided using the water-soluble ODSO from the Reference Example, in diluted form. A 25 mass percent ODSO solution was prepared as a leaching agent composition by adding 6.5 grams (g) of undiluted water-soluble ODSO to 5.5 g of distilled water under gentle stirring. An additional 14 g of distilled water was added and stirred. A quantity of 20 cc of the leaching agent composition was added to a round-bottom flask with a stirrer bar. A quantity of 10 cc of catalyst was added to the solution and continuously stirred at room temperature for 1 hour. After 1 hour of reaction time, the catalyst was filtered from the leaching agent composition. The catalyst was placed in 1 liter of distilled water and stirred for 2 minutes. The catalyst particles were removed, dried at 110° C. The catalyst was analyzed for Mo and Ni and is presented in Table 2 as CAT2.

The ODSO treated catalyst samples and the untreated catalyst samples (UTCAT) were analyzed to determine the leaching performance. Table 2 shows Mo and Ni content of the treated and untreated catalyst samples. The atomic metal data was converted to an oxide basis to ascertain the amount of metal oxide, as shown in Table 3. Table 4 show the metals removal performance using ODSO as an acid, in terms of mass percent of metal removed from the untreated catalyst. Table 4 demonstrates that metal leaching performance for the neat ODSO is 61.5 weight percent (wt %) and 55.5 wt % of MoO₃ and NiO, respectively. The efficiency for MoO₃ removal is higher when ODSO is diluted in which 77.6 wt % of MoO₃ is removed. However, the efficiency for NiO removal is reduced when using the diluted ODSO, in which 46.2 wt % of NiO is removed.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms ““including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing a embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed, an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

TABLE 1

| ODSO Name | Formula | Structure Examples |
|---|---|---|
| Dialkyl-thiosulfoxide or alkyl-alkane-sulfinothioate | (R—SO—S—R) | 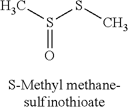 |
| Dialkyl-thiosulfones or Alkyl-Alkane-thiosulfonate | (R—SOO—S—R) | 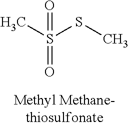 |
| Dialkyl-sulfonesulfoxide Or 1,2-alkyl-alkyl-disulfane 1,1,2-trioxide | (R—SOO—SO—R) | 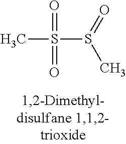 |
| Dialkyl-disulfone Or 1,2 alkyl-alkyl-disulfane 1,1,2,2-tetraoxide | (R—SOO—SOO—R) | 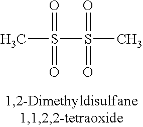 |
| Dialkyl-disulfoxide | (R—SO—SO—R) | 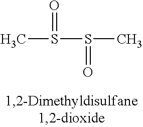 |
| Alkyl-sulfoxidesulfonate | (R—SO—SOO—OH) | 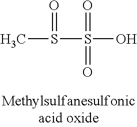 |
| Alkyl-sulfonesulfonate | (R—SOO—SOO—OH) | 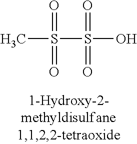 |
| Alkyl-sulfoxidesulfinate | (R—SO—SO—OH) | 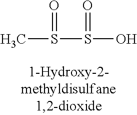 |
| Alkyl-sulfonesulfinate | (R—SOO—SO—OH) | 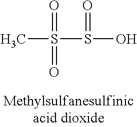 |

TABLE 2

| Sample # | CAT1, wt % | CAT2, wt % | UTCAT, wt % |
|---|---|---|---|
| Mo | 3.87 | 2.25 | 10.04 |
| Ni | 1.53 | 1.85 | 3.44 |

TABLE 3

| Sample # | MW | CAT1, wt % | CAT2, wt % | UTCAT, wt % |
|---|---|---|---|---|
| MoO₃ | 144.0 | 5.8 | 3.4 | 15.1 |
| NiO | 74.7 | 1.9 | 2.4 | 4.4 |

TABLE 4

| | CAT1, wt % | CAT2, wt % |
|---|---|---|
| MoO₃ | 61.45 | 77.59 |
| NiO | 55.52 | 46.22 |

1. (canceled)

2. A method of recovering metal from catalyst material comprising one or more metals from catalyst materials comprising:
providing catalyst material containing metal; and
contacting the catalyst material with a leaching agent composition including one or more oxidized disulfide oil (ODSO) compounds;
wherein at least a portion of metal contained in the catalyst material is extracted into the leaching agent composition.

3. The method of claim 2, wherein the metal contained in the catalyst material comprises one or more metals selected from Periodic Table IUPAC Groups 6, 7, 9 and 10 as catalytically active metal.

4. The method of claim 2, wherein the metal contained in the catalyst material comprises contaminant metal contained on the catalyst material due to prior use of the catalyst material.

5. The method of claim 2, wherein the metal contained in the catalyst material comprises catalytically active metal, and contaminant metal contained on the catalyst material due to prior use of the catalyst material.

6. The method of claim 5, wherein the catalytically active metal is one or more metals selected from Periodic Table IUPAC Groups 6, 7, 9 and 10.

7. The method of claim 5, wherein the catalytically active metal is one or more of Co, Ni, Mo and W.

8. The method of claim 5, wherein the catalytically active metal is one or more rare earth metals.

9. The method of claim 5, wherein the catalytically active metal is one or more of Pt, Pd, Ir and Rh.

10. (canceled)

11. The method of claim 5, wherein the contaminant metal is one or more of Ni, V and Fe.

12. The method as in claim 2, further comprising recovering metals extracted into the leaching agent composition, and using recovered metals for production of alloys or as an active phase metal in a subsequent catalyst synthesis process.

13. (canceled)

14. The method as in claim 2, wherein the metal removal efficacy is in the range of 10-99 wt % relative to an amount of metal in the catalyst material.

15. The method as in claim 2, wherein the leaching agent composition comprises a mixture of ODSO compounds and water at a ratio (V %) of ODSO:H₂O in the range of from 100:0. to 0.1:99.9.

16. The method as in claim 2, wherein the leaching agent composition further comprises one or more additional leaching compound(s).

17. The method of claim 16, wherein the additional leaching compound(s) include one or more of hydrochloric acid, sulfuric acid and nitric acid.

18. The method of claim 16, wherein the additional leaching compound(s) include one or more of oxalic acid, lactic acid, citric acid, glycolic acid, phthalic acid, malonic acid, succinic acid, salicylic acid and tartaric acid.

19. The method as in claim 2, further comprising contacting the catalyst material with an oxidizing agent.

20. The method as in claim 2, wherein the one or more ODSO compounds are derived from oxidation of disulfide oil compounds present in an effluent refinery hydrocarbon stream recovered following catalytic oxidation of mercaptans present in a mercaptan-containing hydrocarbon stream.

21-23. (canceled)

24. The method as in claim 2:
wherein the ODSO compounds are selected from the group consisting of (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR):
or
wherein the ODSO compounds include two or more compounds selected from the group consisting of (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (X—SO—OR) and (X—SOO—OR—);
wherein R and R′ are alkyl or aryl groups comprising 1-10 carbon atoms and wherein X denotes esters and is (R—SO) or (R—SOO).

25-26. (canceled)

27. The method as in claim 2:
wherein the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH), (X—SO—OR) and (X—SOO—OR);
wherein the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH), (X—SO—OR) and (X—SOO—OR);
wherein the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH);
or
wherein the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH);
wherein R and R′ are alkyl or aryl groups comprising 1-10 carbon atoms and wherein X denotes esters and is (R—SO) or (R—SOO).

28-30. (canceled)

31. The method as in claim 2:
wherein the ODSO comprises ODSO compounds contained in a pH-modified water-soluble ODSO composition comprising an aqueous mixture of one or more water-soluble ODSO compounds and an effective amount of an alkaline agent, and wherein the leaching agent composition is acidic; or
the ODSO comprises ODSO compounds contained in a supernatant from a prior synthesis that utilized water-soluble ODSO as a component, and wherein the leaching agent composition is acidic.

32. (canceled)
